(19) United States
(12) Patent Application Publication
(10) Pub. No.: US 2021/0401551 A1
(43) Pub. Date: Dec. 30, 2021

(54) METHOD OF MANUFACTURING DENTURE BY USING TRAY CAP JIG HAVING FALSE TEETH FIXED UNMOVABLY DURING MILLING FALSE TEETH

(71) Applicants: Yunsoon KIM, Duluth, GA (US); DENTSOLLPRIME CO., LTD., Damyang-gun Jeollanam-do (KR)

(72) Inventor: Yunsoon KIM, Duluth, GA (US)

(21) Appl. No.: 16/625,216

(22) PCT Filed: Apr. 5, 2019
(86) PCT No.: PCT/KR2019/004089

§ 371 Date: Dec. 20, 2019

(30) Foreign Application Priority Data
Mar. 19, 2019 (KR) 10-2019-0030960

(51) Int. Cl. A61C 13/00; A61C 13/12

(52) U.S. Cl. CPC A61C 13/0019; A61C 13/0004; A61C 13/12

(57) ABSTRACT

The present inventive concept relates to a method of manufacturing dentures by using a tray cap jig having false teeth fixed unmovably during milling thereof, the tray cap jig, which is depressed, being manufactured according to a rectangular parallelepiped shape or the same shape as the teeth arrangement in an oral cavity set by a dental denture design software of a 3D printer, the method including: manufacturing the tray cap jig of the same shape as the shape of a rectangular parallelepiped container or teeth arrangement in an oral cavity by using the 3D printer; inserting false teeth into a false teeth hole provided in the depressed tray cap jig; and cutting each of roots of the false teeth to a depth set by the dental denture design software after inserting the false teeth into the tray cap jig.

### CROSS-REFERENCE TO RELATED APPLICATIONS

This application claims priority to and the benefit of Korean Patent Application No. 10-2019-0030960, filed on Mar. 19, 2019 and PCT Application No PCT/KR2019/004089, filed on Apr. 5, 2019, the entire contents of which are incorporated herein by reference.

### BACKGROUND

The present inventive concept relates to a tray cap jig, which is used to mill false teeth, manufactured by 3D printing such that the false teeth are inserted into and fixed to the tray cap jig so as not to move. More particularly, during milling work by using a tray cap jig in which false teeth are embedded and having a rectangular parallelepiped shape or the same shape as teeth arrangement in an oral cavity, each of roots of the false teeth is cut to the same depth as a depth of each of original teeth of a wearer thereof set by a dental denture design software; the portions of the processed teeth are inserted into a gum structure; and dentures are completely manufactured. In this case, an aesthetically excellent depressed jig (the tray cap jig), which is precise, convenient, quick, and economical in manufacturing dentures, is manufactured in a rectangular parallelepiped shape or the same shape as teeth arrangement in an oral cavity set by the dental denture design software of a 3D printer.

In this case, a separation membrane may be provided between each of the false teeth to hold the false teeth such that the false teeth are easily processed and fixed properly.

Generally, a method of implanting false teeth when teeth in an oral cavity of a person are lost or damaged has been developed, and particularly, dentures using the false teeth have been efficiently developed along with the method of implanting. As a conventional technique on a method of manufacturing the dentures, there is disclosed an assembly type denture apparatus in Korean Patent No. 10-1867040, the apparatus including: a denture base having a corresponding groove part provided on a first end part thereof, the groove part corresponding to a surface profile of the gum object, such that false teeth prosthetic teeth are in close contact with and fixed to a surface of a gum object and having a combination protruding part provided on a second end part thereof so as to correspond to a dental arch line of the gum object; and a false teeth part having a masticatory surface provided on a second end part thereof, the masticatory surface corresponding to a tooth type by position of the dental arch line and having an insertion groove provided on a first end part thereof, the insertion groove into which the combination protruding part is inserted, so as to be combined with the second end part of the denture base, wherein an outer surface profile of the artificial teeth part, which has masticatory cross-sections by tooth types provided from a digital library, is set on the basis of virtual artificial teeth of a virtual dental template extracted according to a circular arc length of the dental arch line and an occlusion height up to an occlusion object from the gum object, wherein the virtual artificial teeth are provided to have a width and a height standardized according to the circular arc length and the occlusion height, the virtual artificial teeth having virtual insertion grooves provided therein, the insertion groove corresponding to each shape and volume thereof, and an outer surface profile of the combination protruding part is set so as to correspond to the virtual insertion grooves of the virtual artificial teeth.

In addition, in Korean Patent No. 10-1682285, there is disclosed a method of producing false teeth, the false teeth having a base element supporting at least two tooth blanks, the method including: producing a negative mold by machining on the basis of a digital image of a tooth state; shortening, by machining, lengths of the tooth blanks, which are held and preassembled in the negative mold, from a basal side in order to achieve a tooth line suitable for the tooth state; and connecting the base element with the shortened tooth blanks so as to form the dentures.

However, a milling work for the conventional denture manufacturing is required to manufacture each of the false teeth according to each size thereof, whereby working speed is slow, manufacturing cost increases, and working precision decreases.

False teeth for dentures manufactured by 3D printing have low beauty and low strength, and are manufactured slowly, thereby being expensive to manufacture.

In the past, manufacturing the tray cap jigs as shapes of original teeth in a manufacturer took much time, effort, and expense since there are many shapes and sizes of teeth, and it was difficult to meet precision required by a dental denture design software.

### SUMMARY

Accordingly, the present inventive concept provides a method of manufacturing dentures by using a tray cap jig having false teeth fixed unmovably during milling of the false teeth, wherein during the milling work by using the tray cap jig, each of roots of the false teeth is cut to the same depth as a depth of each of original teeth of a wearer thereof and the false teeth are inserted into a gum structure, and dentures are manufactured. Accordingly, denture manufacturing is precise, convenient, and quick.

The present inventive concept relates to the tray cap jig, which is used to mill false teeth, manufactured by 3D printing such that the false teeth are inserted into and fixed to the tray cap jig so as not to move.

The present inventive concept relates to a method of manufacturing dentures by using the tray cap jig. More particularly, the present inventive concept relates to a method of manufacturing dentures by using the tray cap jig having false teeth fixed unmovably during milling of the false teeth, wherein during the milling work by using the tray cap jig in which false teeth are embedded and having a rectangular parallelepiped shape or the same shape as the teeth arrangement in an oral cavity, each of the roots of the false teeth is cut to the same depth as a depth of each of original teeth of a wearer thereof set by a dental denture design software; the portions of the processed teeth are inserted into the gum structure; and dentures are completely manufactured. In this case, the aesthetically excellent depressed the tray cap jig, which is precise, convenient, quick, and economical in manufacturing the dentures, is manufactured in a rectangular parallelepiped shape or the same shape as the teeth arrangement in an oral cavity set by the dental denture design software of a 3D printer.

The present inventive concept relates to a tray cap jig, which is used to mill false teeth, manufactured by 3D printing such that the false teeth are inserted into and fixed to the tray cap jig so as not to move.

The present inventive concept relates to a method of manufacturing dentures by using the tray cap jig. More particularly, the present inventive concept relates to a method of manufacturing dentures by using the tray cap jig having false teeth fixed unmovably during milling of the false teeth, wherein during the milling work by using the tray cap jig in which false teeth are embedded and having a rectangular parallelepiped shape or the same shape as the teeth arrangement in an oral cavity, each of roots of the false teeth may be cut to the same depth as a depth of each of original teeth of a wearer thereof set by a dental denture design software; the portions of the processed teeth may be inserted into a gum structure; and dentures may be completely manufactured. In this case, an aesthetically excellent depressed the tray cap jig, which is precise, convenient, quick, and economical in manufacturing dentures, may be manufactured in a rectangular parallelepiped shape or the same shaper as the teeth arrangement in an oral cavity set by the dental denture design software of a 3D printer.

Accordingly, according to the present inventive concept, when manufacturing a tray cap jig by 3D printing, a manufacturer can manufacture the tray cap jig as each of different shapes of teeth.

Accordingly, in the present inventive concept, a shape of the tray cap jig can be efficiently formed by 3D printing as a shape of false teeth manufactured by a manufacturer, so that problems of the prior art can be solved.

In addition, when a customized tray cap jig is manufactured as a shape of teeth by 3D printing, numerous manufacturers can easily provide various false teeth having aesthetic and functional features of the teeth to patients.

In addition, a process of manufacturing the false teeth is also complemented, and thus instead of 3D printing or milling the entirety of the false teeth, only roots of the false teeth are simply manufactured by using a customized tray cap jig made by 3D printing, whereby manufacturing time is considerably reduced and thus manufacturing cost is significantly reduced.

### BRIEF DESCRIPTION OF THE DRAWINGS

FIG. 1 is a perspective view of a tray cap jig of the present inventive concept;

FIG. 2 is a view showing a state of false teeth of the present inventive concept inserted into a false teeth hole in the tray cap jig;

FIG. 3 is a view showing a state of a soft sealing material filled in a vicinity of false teeth in a tray cap jig according to one embodiment of the present inventive concept; and

FIG. 4 is a view illustrating the manufacturing of undercuts in the false teeth of the present inventive concept.

### DETAILED DESCRIPTION

The present inventive concept relates to a method of manufacturing dentures by using a tray cap jig having false teeth fixed unmovably during milling of the false teeth, the tray cap jig, which is depressed, being manufactured to have a rectangular parallelepiped shape or the same shape as an oral cavity set by a dental denture design software of a 3D printer, the method including:
manufacturing the tray cap jig having a rectangular parallelepiped shape or the same shape as an oral cavity by using the 3D printer; inserting false teeth into a false teeth hole provided in the depressed tray cap jig; and cutting each of roots of the false teeth to a depth set by the dental denture design software after inserting the false teeth into the tray cap jig.

In addition, at the same time when each of the roots of the false teeth is cut, undercuts are also manufactured in the false teeth and a gum structure. The undercuts are structures preventing the false teeth and the gum structure, which are main structures, from detaching from each other when the false teeth and the gum structure are bonded to each other.

Furthermore, the processed false teeth are inserted into and embedded in the gum structure, wherein the gum structure is processed by milling or 3D printing, and a false teeth groove of the gum structure in which the processed false teeth are embedded is also manufactured by milling or 3D printing at the same time.

Additionally, the tray cap jig has a false teeth hole of a rectangular shape formed therein. Multiple false teeth are inserted into the false teeth hole, and because every wearer of the false teeth has teeth of different sizes, the shape and size of the false teeth hole may be formed differently, and a size of an inner part of the depressed tray cap jig of the present inventive concept may be different. However, an outer surface of the tray cap jig has the same size such that the tray cap jig is constantly combined with an outer jig for milling, which supports the tray cap jig.

Furthermore, after multiple false teeth are inserted into the false teeth hole, a soft sealing material such as silicon is filled therein such that the false teeth do not break away therefrom even during milling.

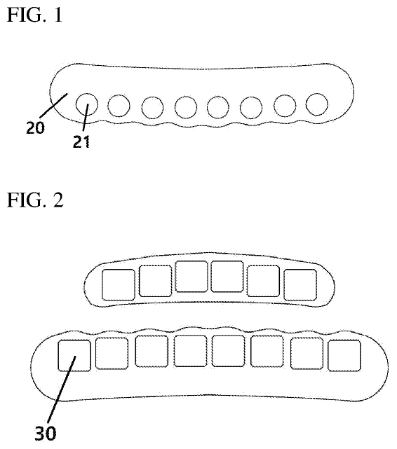

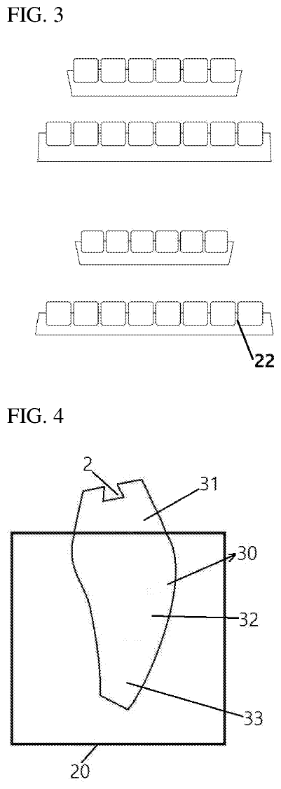

The present inventive concept will be described in detail by the accompanying drawings as follows. FIG. 1 is a perspective view of a tray cap jig of the present inventive concept; FIG. 2 is a view showing a state of false teeth of the present inventive concept inserted into the false teeth hole in the tray cap jig; FIG. 3 is a view showing a state of a soft sealing material filled in a vicinity of false teeth in a tray cap jig according to one embodiment of the present inventive concept; and FIG. 4 is a view illustrating the manufacturing of the undercuts in the false teeth of the present inventive concept.

The present inventive concept relates to the tray cap jig, which is used to mill the false teeth, manufactured by 3D printing. The false teeth are inserted into and fixed to the tray cap jig not to move.

During milling work by using the tray cap jig 20 having a rectangular parallelepiped shape or the same configuration as teeth arrangement in an oral cavity, each of roots 10 of the false teeth is cut to the same depth as a depth of each of original teeth of a wearer thereof set by the dental denture design software; the portions of the processed teeth are inserted into the gum structure; and dentures are completely manufactured. In this case, an aesthetically excellent depressed tray cap jig 20 (the tray cap jig), which is precise, convenient, quick, and economical in manufacturing dentures, is manufactured in accordance with the rectangular parallelepiped shape or the same configuration as the teeth arrangement in an oral cavity set by the dental denture design software of the 3D printer. That is, according to the present inventive concept, false teeth 30 are embedded side by side along a straight line in the tray cap jig 20 having the rectangular parallelepiped shape or the same configuration as the teeth arrangement in an oral cavity. The tray cap jig 20 is manufactured of materials provided by the 3D printer to have rigidity. The tray cap jig 20 is manufactured to be thin enough to have elasticity. The tray cap jig 20 has a false teeth hole 21 formed therein, and multiple false teeth are embedded in the false teeth hole. When embedding the false teeth in the tray cap jig 20, roots 10 of the false teeth which was embedded in the gum structure face upward and end parts of teeth chewing food face downward. This is intended to efficiently manufacture the root parts and the undercuts in milling work, which is a later process.

In addition, because every wearer of the false teeth has teeth of different sizes, a depth and a width of the false teeth hole 21 in which the false teeth are embedded may be formed differently depending on every wearer of the false teeth even though outer shape and size of the tray cap jig 20 is the same.

Particularly, the tray cap jig 20 surrounding the multiple false teeth may be manufactured by 3D printing according to a shape of false teeth set by the dental denture design software according to the shape and size of original teeth.

Furthermore, according to one embodiment of the present inventive concept, after multiple false teeth 30 are inserted into the false teeth hole 21, a soft sealing material 22 such as silicon is filled in an empty space between the false teeth hole 21 and the false teeth 30, so that the false teeth do not detach therefrom even during milling Next, the tray cap jig 20 is arranged on the milling machine (not shown) and the milling work is performed thereon. In this case, each of the roots 10 of the false teeth provided in the tray cap jig 20 is cut to a depth set by a software of a controller of the milling machine. That is, each of the roots of the false teeth may be cut to the same height and size as a height and a size of each of original teeth of a wearer thereof.

Finally, the processed false teeth are inserted into and embedded in the gum structure so as to complete the dentures.

A material of the gum structure of the present inventive concept is polymethyl methacrylate (PMMA) or nylon and uses color similar to pink color, and may use darker or lighter color according to brightness desired. The gum structure is manufactured by milling or 3D printing, and at the same time, the false teeth groove in which the false teeth are embedded is also processed by milling or 3D printing. In this case, the undercuts 2 are provided in portions of the roots and in the gum structure so as to manufacture dentures, whereby a strength by which the false teeth are combined with the gum structure by an adhesive such as a bond is excellent and denture manufacturing is precise, convenient, quick, and economical.

Accordingly, according to the present inventive concept, after the tray cap jig 20, in which false teeth are embedded, is manufactured in the rectangular parallelepiped shape or the same shape as teeth arrangement in an oral cavity by the denture design software, the false teeth are embedded side by side along a straight line in the tray cap jig 20. In this case, a separation membrane may be installed between each of the false teeth to hold the false teeth such that the false teeth are easily processed and fixed properly, and the separation membrane has a shape of a normally flat membrane and functions to separate each of the false teeth therebetween.

In addition, after each of the roots of the false teeth is cut to the same depth as a depth of each of original teeth of a wearer thereof, the false teeth are inserted into the gum structure so as to manufacture the dentures, whereby denture manufacturing is precise, convenient, quick, and economical.

1.-3 (canceled)

4. A method of manufacturing dentures, the method comprising:
manufacturing a tray cap jig having a rectangular parallelepiped shape or the same shape as teeth arrangement in an oral cavity by using the 3D printer, the tray cap jig having a false teeth hole in the middle;
inserting a plurality of false teeth into the false teeth hole in the tray cap jig; and
cutting each of roots of the plurality of false teeth to a depth set by the dental denture design software after inserting the plurality of false teeth into the false teeth hole in the tray cap jig.

5. The method of claim 4, wherein the plurality of false teeth are inserted into the false teeth hole to expose roots of the plurality of false teeth.

6. The method of claim 5, further comprising:
forming undercuts in on ends of the exposed roots of the plurality of false teeth, the undercuts being a recessed portion extending from an end of the exposed roots toward a body of the plurality of false teeth.

7. The method of claim 6, wherein the tray cap jig includes a separation membrane provided between each of the plurality of false teeth.

8. The method of claim 6, further comprising:
inserting the processed false teeth into a gum structure so as to be embedded therein.

9. The method of claim 8, wherein the gum structure is processed by milling or 3D printing and the gum structure includes a false teeth groove in which the processed false teeth are embedded.

10. The method of claim 9, wherein the tray cap jig has a rectangular parallelepiped shape or the same shape as teeth arrangement in an oral cavity.
